(19) United States
(12) Patent Application Publication
(10) Pub. No.: US 2008/0220812 A1
(43) Pub. Date: Sep. 11, 2008

(54) PORTABLE ELECTRONIC DEVICE WITH MOVABLE SPEAKER

(75) Inventor: KUANG-HSIEN WANG, Jen Te (TW)

Correspondence Address: PCE INDUSTRY, INC.;ATT. CHENG-JU CHIANG, 458 E. LAMBERT ROAD, FULLERTON, CA, 92835, US

(73) Assignee: CHI MEI COMMUNICATION SYSTEMS, INC., Tainan County (TW)

(21) Appl. No.: 11/777,069

(22) Filed: Jul. 12, 2007

(30) Foreign Application Priority Data
Mar. 9, 2007 (CN) 200710073464.5

(51) Int. Cl. H04Q 7/20

(52) U.S. Cl. 455/550.1

(57) ABSTRACT

A portable electronic device (40) includes a main body (10), a speaker (20), and a latching mechanism (30). The speaker is movable relative to the main body and has a positioning stop member (262) associated therewith. The latching mechanism is mounted in a longitudinal side of the main body and has a latching body (31). The latching body is configured for selectable biased engagement with the positioning stop member to enable the speaker to be selectably retained within the main body. The speaker further includes a speaker-driving elastic member (28), and the main body further includes a partition wall (132) and has a cavity (131) defined therein. The partition wall is in communication with the cavity. A first end of the speaker-driving elastic member resists the partition wall, and a second opposite end of the speaker-driving elastic member resists the speaker.

### BACKGROUND OF THE INVENTION

1. Field of the Invention

The present invention relates to portable electronic devices and, particularly, to a portable electronic device configured (i.e., structured and arranged) for having at least one movable speaker.

2. Description of Related Art

Nowadays, portable electronic devices such as mobile phones and PDAs (personal digital assistants) are in widespread use around the world. Some high-end portable electronic devices are being developed to be increasingly multi-functional. Many of these portable electronic devices are now equipped with a MP3 (i.e., Moving Picture Experts Group Audio Layer III, MPEG AudioLayer-3) module. These electronic devices can enable consumers to enjoy music anytime and anywhere.

A given portable electronic device with a MP3 module has a speaker formed on one end thereof. The speaker is used for converting electrical signals from a phone call into sounds and for playing music stored in the MP3 module. When listening to the call, the end with the speaker of the portable electronic device is placed near a user's ear. While playing music, the user may place the portable electronic device in a hand, in a bag, or on a desk. However, the single speaker can only emit sound in one direction and cannot provide stereo capability and, thus, does not fully suit the use of the portable electronic device with an MP3 player as a stationary music player.

A new portable electronic device with a movable speaker is desired in order to overcome the above-described problems.

### SUMMARY

In one aspect thereof, a portable electronic device includes a main body, a speaker, and a latching mechanism. The speaker is movable relative to the main body and has a positioning stop member configured for facilitating control of movement thereof. The latching mechanism is formed or mounted on the main body and has a latching body. The latching body is configured for releasably/detachably engaging with the positioning member.

Other advantages and novel features of the embodiments will become more apparent from the following detailed description thereof, when taken in conjunction with the accompanying drawings.

### BRIEF DESCRIPTION OF THE DRAWINGS

Many aspects of the present portable electronic device can be better understood with reference to the following drawings. The components in the drawings are not necessarily drawn to scale, the emphasis instead being placed upon clearly illustrating the principles of the present portable electronic device and its potential applications. Moreover, in the drawings, like reference numerals designate corresponding parts throughout the several views.

FIG. 1 is an assembled, isometric view of a portable electronic device in a speaker operational state, in accordance with a present embodiment;

FIG. 2 is an assembled, isometric view of the portable electronic device of FIG. 1, shown in a speaker non-operational state;

FIG. 3 is an exploded, isometric view of the portable electronic device, as shown in FIGS. 1 and 2; and

FIG. 4 is an enlarged, partially cut-away view of the portable electronic device, as shown in FIG. 2.

### DETAILED DESCRIPTION OF THE EMBODIMENTS

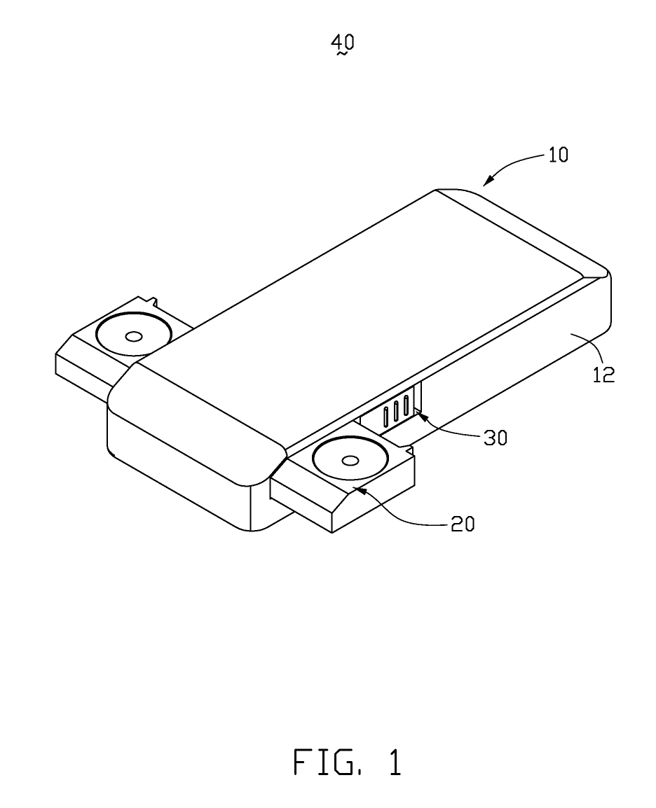

Referring now to the drawings in detail, FIG. 1 shows a portable electronic device 40. The portable electronic device 40 includes a main body 10, two speakers 20, and two latching mechanisms 30. Each speaker 20 is movably mounted to one respective side of the main body 10 by a corresponding latching mechanism 30.

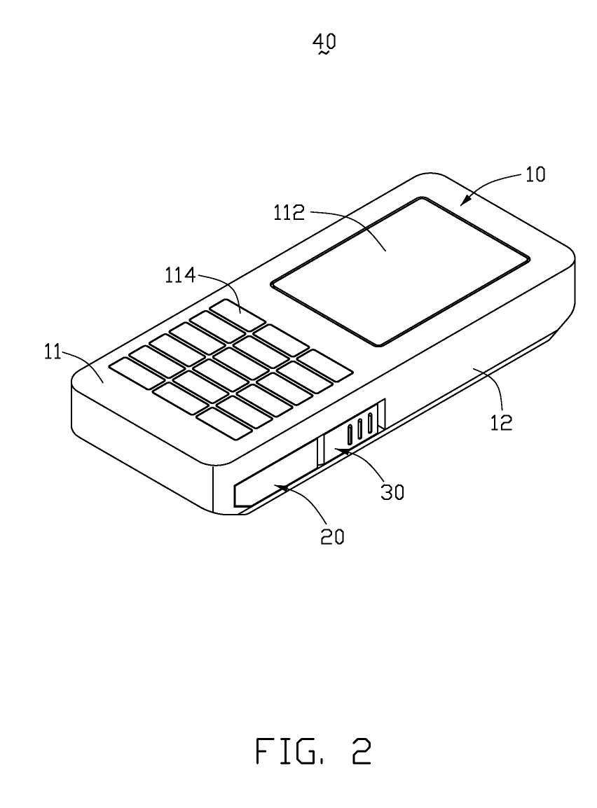

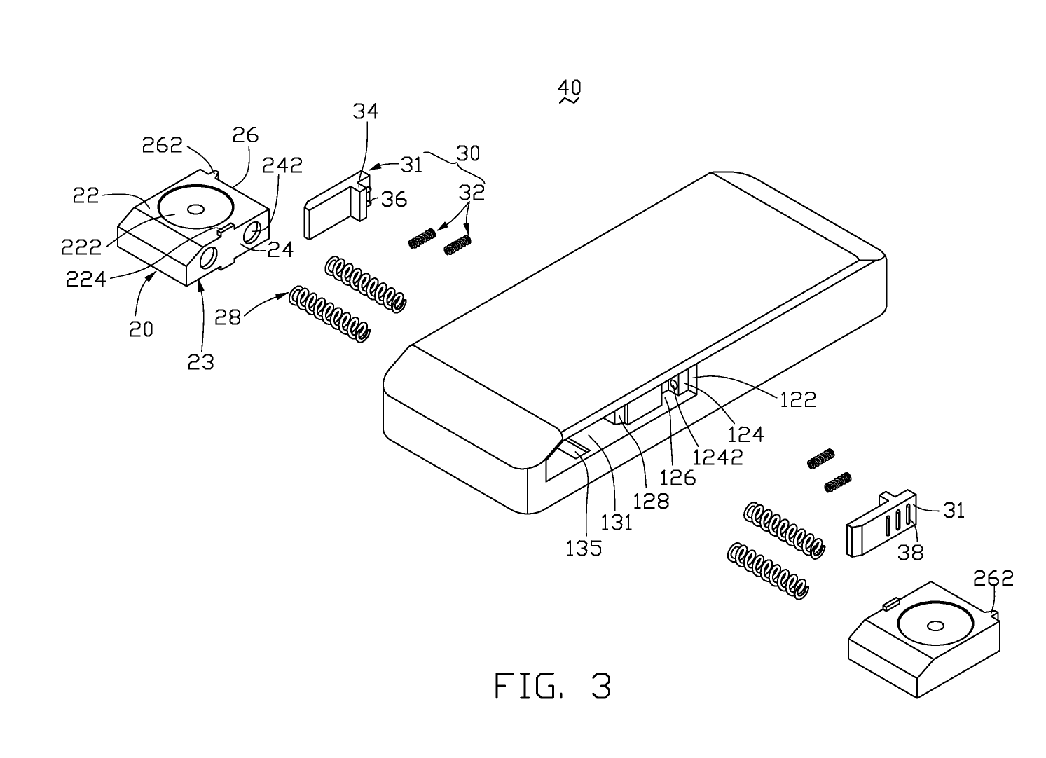

Also referring to FIGS. 2-4, the main body 10 is substantially rectangular in shape and has a top surface 11 and two opposite longitudinal sides 112. A display 112 and a keypad 114 are provided on the top surface 11, from top to bottom. Each longitudinal side 12 defines a groove 122 (i.e., an inner side surface) and a slot 126 therein. The slot 126 communicates with the groove 122, and thereby a stage 124 is formed within the side 12. The stage 124 defines two stage positioning holes 1242 therein, each communicating with the slot 126. The two longitudinal sides 12 define two respective cavities 131 therein, divided by a partition wall 132 positioned within the main body 10 (e.g., a separate element or co-molded as part of the main body 10). Each cavity 131, of course, respectively faces outwardly via the corresponding longitudinal side 12 through which it opens, and each cavity 131 further communicates with a respective groove 122. The partition wall 132 has two opposing surfaces, each surface facing and thus communicating with a respective cavity 131. Two receiving holes 133 are defined in each opposing surface. A first pole 134 extends perpendicularly from the partition wall 132 into one respective receiving hole 133 and cavity 131. The main body 10 defines two pairs of guiding slots 135 therein. Each pair of guiding slots 135 respectively communicates with a corresponding cavity 131. The main body 10 further defines two cutouts 128. Each cutout 128 communicates with a corresponding groove 122 and a corresponding cavity 131.

Each speaker 20 is configured (i.e., structured and arranged) for being receivable in a corresponding cavity 131. Each speaker 20 includes a speaker body (not labeled) and two speaker-driving first elastic members 28. Each speaker body is a substantially rectangular block in shape and has a top body surface 22, a bottom body surface 23 opposite/opposing to the top body surface 22, a first body side 24, and a second body side 26. The second body side 26 is adjacent to and is oriented substantially perpendicularly to the first body side 24. The top body surface 22 defines a round opening 222 configured for receiving electronic components (e.g., audio elements, not shown) therein. Two body guiding protrusions 224 extend respectively from the top body surface 22 and the bottom body surface 23 and are adjacent to the first body side 24. Each body protrusion 224 is configured for being slidable in a corresponding guiding slot 135 of the main body 10, thereby enabling the speaker 20 to selectably slide in or out relative to the main body 10.

Each first body side 24 defines two positioning holes 242 therein. Each positioning hole 242 is configured for receiving a first end of a corresponding first elastic member 28. A second opposite end of each first elastic member 28 is configured for being slidably mounted around a corresponding first pole 134 of the main body 10. A positioning block 262 is formed on one end (i.e., directly extending therefrom, either molded as part of the given second body side 26 or attached directly thereto) of each second body side 26 and is located far away (i.e., nearly diametrically opposed) from the first body side 24. Each positioning block 262 is configured for being receivable in a corresponding cutout 128 of the main body 10 and is configured to serve as stop element, via which the corresponding speaker 20 can be held within a respective cavity 131. The first elastic members 28 advantageously are made of metal and are spiral-shaped (i.e., a coil spring).

Each latching mechanism 30 is movably mounted in a respective longitudinal side 12 and includes a latching body 31 and two latch-driving second elastic members 32, which are each advantageously made of metal and are spiral-shaped (e.g., coil springs). Each latching body 31 is substantially rectangular in shape and is configured for being receivable in the groove 122 of the main body 10. A guiding block 34 extends perpendicularly from a first side of the latching body 31. Two second poles 36 extend perpendicularly from the guiding block 34 and are substantially parallel to an extending direction of the latching body 31. A first end of each second elastic member 32 is configured for wrapping/sliding around a corresponding second pole 36 in a manner such that a given second pole 36 is matingly received (e.g., slidably fits) within the first end of a corresponding second elastic member 32. An opposite second end of each second elastic member 32 is configured for being matingly receivable in a corresponding positioning hole 1242 of the main body 10. An opposite second side of the latching body 31 is provided with a plurality of strip-shaped projections 38, each configured for facilitating operation of pulling the latching body 31.

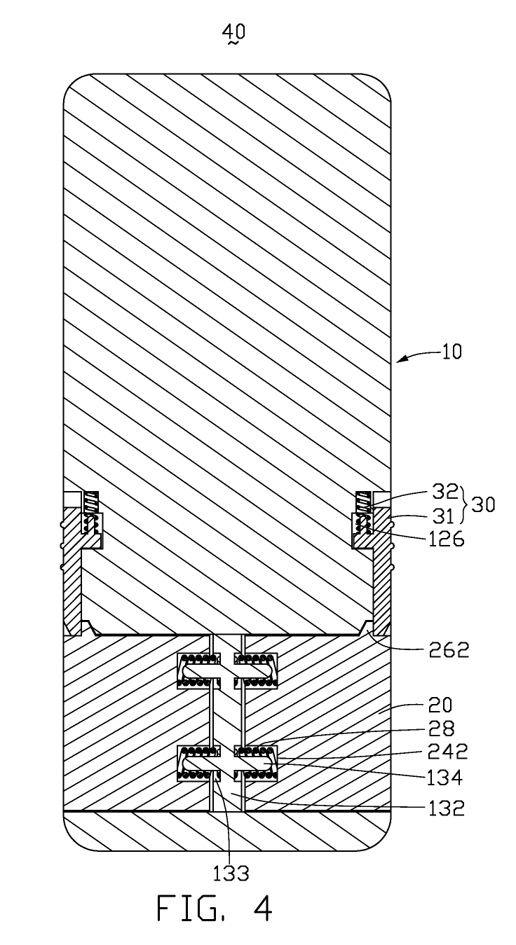

Also referring to FIG. 4, in assembly, the first end of each first elastic member 28 is placed around a corresponding first pole 134, and located in a corresponding receiving hole 133 of the main body 10. Each speaker 20 is inserted into the cavity 131, with the second end of each first elastic member 28 being received in a corresponding positioning hole 242, and each guiding protrusion 224 being received in a corresponding guiding slot 135, until each positioning block 262 is received in a corresponding cutout 128 (i.e., now at a fully retracted position of a given speaker 20). The first elastic members 28 are compressed. Then, the first end of each second elastic member 32 is placed around a corresponding second pole 36 of the latching body 31. The second end of each second elastic member 32 is inserted into a corresponding positioning hole 1242 of the main body 10, and the latching body 31 is placed in the groove 122 of the main body 10, with the guiding block 34 being received in a corresponding slot 126. Each second elastic member 32 is then permitted to expand to push the latching body 31 to resist/abut the positioning block 262 (i.e., specifically abutting a side of the positioning block 22 facing the corresponding longitudinal side 12) in the cutout 128. Such abutment thereby prevents the speaker 20 from moving out of the cavity 131 (i.e., thus retaining the speaker 20 therein), due to the decompression (i.e., expansion) of the first elastic members 28. Thus, the speakers 20 are respectively mounted into the main body 10 and held therein by the corresponding latching mechanisms 30, as shown in FIGS. 2 and 4.

Also referring to FIG. 1, in use, the latching body 31 of each latching mechanism 30 can be pulled away from the respective speaker 20 and the respective cavity 131, by pulling the projections 38 of a given latching body 31, by a user. The second elastic member 32 is further compressed and the latching body 31 disengages from the positioning block 262. Then, the speaker 20 is automatically pushed out of the cavity 131, due to the decompression of the first elastic members 28. Now, the user can listen music with dimensional sounds (i.e., in stereo) through two speakers 20. When the speakers 20 are not in use, the speakers 20 can be manually pushed back into the cavities 131, after the respective first elastic members 28 are compressed to retract an appropriate latching body 31. Once a speaker 20 is in place within a corresponding cavity 131, the corresponding latching body 31 is released and is automatically moved toward the speaker 20, due to the decompression of the second elastic members 32, to resist the positioning block 262. Thus, the speakers 20 are held in the main body 10.

It should be understood that there may be only one movable speaker 20. The other speaker may be a conventional speaker fixed in the main body 10 (e.g., in the standard earphone location at the top of the main body 10). Furthermore, the number of the speakers 20 may be three or more. The positioning block 262 may be another positioning stop member, such as a hole defined in the second body side 26 of the speaker 20, and correspondingly, one end of the latching body 31 can be configured to be receivable in the hole so as to hold the speaker 20 in the main body 10. The first and second elastic members 28, 32 may alternatively be made of another material (e.g., plastic or rubber) and may alternatively have a different configuration, for example, a leaf spring or an elastic or elastomeric cylinder.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A portable electronic device comprising:
a main body;
a speaker being movable relative to the main body and having a positioning stop member extending therefrom; and
a latching mechanism movably attached to the main body and having a latching body, wherein the latching body is configured for selectably engaging with the positioning stop member to enable control of movement of the speaker relative to the main body.

2. The portable electronic device as claimed in claim 1, wherein the speaker is substantially rectangular in shape, the positioning stop member is formed on a first body side of the speaker, the main body defines a longitudinal side surface and a cavity, the cavity extends into the main body via the longitudinal side surface, and the cavity is configured for receiving the speaker.

3. The portable electronic device as claimed in claim 2, wherein the speaker also has a second body side, the second body side is adjacent to and oriented substantially perpendicularly to the first body side, the speaker further includes a speaker-driving elastic member, the main body further including a partition wall therein, the partition wall is in communication with the cavity, a first end of the speaker-driving elastic member resists the partition wall of the main body, and a second opposite end of the speaker-driving elastic member resists the second body side of the speaker.

4. The portable electronic device as claimed in claim 3, wherein a pole extends from the partition wall of the main body and into the cavity of the main body, and the first end of the speaker-driving elastic member fits around the pole.

5. The portable electronic device as claimed in claim 3, wherein the second body side of the speaker defines a positioning hole therein configured for receiving the second end of the speaker-driving elastic member.

6. The portable electronic device as claimed in claim 2, wherein the main body defines a groove therein adjacent to the cavity of the main body, the groove being configured for receiving the latching body of the latching mechanism.

7. The portable electronic device as claimed in claim 6, wherein the latching mechanism further includes at least one latch-driving elastic member, a first end of each latch-driving elastic member resists the latching body, and a second opposite end of each latch-driving elastic member resists the main body.

8. The portable electronic device as claimed in claim 7, wherein a guiding block extends perpendicularly from the latching body and inwardly toward the main body, a pole extends perpendicularly from the guiding block, and the first end of the latch-driving elastic member fits around the pole of the latching mechanism.

9. The portable electronic device as claimed in claim 8, wherein the main body defines a slot therein, the slot communicates with the hole of the main body and a stage is formed in the main body, the stage defines a positioning hole therein configured for receiving the second end of the latch-driving elastic member.

10. The portable electronic device as claimed in claim 7, wherein the at least one latch-driving elastic member is configured for biasing the latching body toward the speaker.

11. The portable electronic device as claimed in claim 10, wherein, when the speaker is retracted into the main body, the latching body is selectably capable of engaging the positioning stop member in a manner that retains the speaker within the main body.

12. The portable electronic device as claimed in claim 6, wherein the main body defines a cutout therein configured for receiving the positioning stop member, and the cutout communicates with the groove of the main body.
